(19) United States
(12) Patent Application Publication
(10) Pub. No.: US 2013/0188740 A1
(43) Pub. Date: Jul. 25, 2013

(54) METHOD AND APPARATUS FOR ENTROPY ENCODING/DECODING

(71) Applicants: Sung Chang Lim, Daejeon (KR); Hui Yong Kim, Daejeon (KR); Se Yoon Jeong, Daejeon (KR); Suk Hee Cho, Daejeon (KR); Jong Ho Kim, Daejeon (KR); Ha Hyun Lee, Seoul (KR); Jin Ho Lee, Daejeon (KR); Jin Soo Choi, Daejeon (KR); Jin Woong Kim, Daejeon (KR); Chie Teuk Ahn, Daejeon (KR); Hae Chul Choi, Daejeon (KR)

(72) Inventors: Sung Chang Lim, Daejeon (KR); Hui Yong Kim, Daejeon (KR); Se Yoon Jeong, Daejeon (KR); Suk Hee Cho, Daejeon (KR); Jong Ho Kim, Daejeon (KR); Ha Hyun Lee, Seoul (KR); Jin Ho Lee, Daejeon (KR); Jin Soo Choi, Daejeon (KR); Jin Woong Kim, Daejeon (KR); Chie Teuk Ahn, Daejeon (KR); Hae Chul Choi, Daejeon (KR)

(73) Assignees: Industry-Academic Coooperation Foundation Hanbat National University, Daejeon (KR); Electronics and Telecommunications Research Institute, Daejeon (KR)

(21) Appl. No.: 13/822,582

(22) PCT Filed: Sep. 9, 2011
(86) PCT No.: PCT/KR2011/006726

§ 371 Date: Mar. 12, 2013

(30) Foreign Application Priority Data
Sep. 13, 2010 (KR) 10-2010-0089697
Sep. 9, 2011 (KR) 10-2011-0091755

(51) Int. Cl. H04N 7/26

(52) U.S. Cl. CPC H04N 19/00424
USPC 375/240.25

(57) ABSTRACT

Provided is an entropy decoding method. The entropy decoding method according to the present invention comprises the steps of: drawing context information about a symbol to be decoded using at least either context information about corresponding layer or context information about other layers; and performing entropy decoding on the symbol using the drawn context information. According to the present invention, image compression efficiency can be enhanced.

Disclosed herein is an entropy decoding method. The entropy decoding method according to exemplary embodiments of the present invention includes: deriving context information on decoding object symbols by using at least one of context information on an object layer and context information on other layers; and performing entropy decoding on the decoding object symbols by using the derived context information. According to the exemplary embodiment of the present invention, video compression efficiency can be improved.

### TECHNICAL FIELD

The present invention relates to image processing, and more particularly, to entropy coding/decoding method and apparatus.

### BACKGROUND ART

Recently, broadcasting services having high definition (HD) resolution have been widely distributed to the country and throughout the whole world, such that a lot of users become accustomed to high-resolution and high-definition videos. As a result, numerous organizations have focused on developing next-generation video devices. In addition, the interest in HDTV and ultra high definition (UHD) having a resolution four times higher than that of HDTV has been increased and thus, a compression technology for higher-resolution and higher-definition videos has been required.

For the video compression, an inter prediction technology predicting pixel values included in a current picture from a picture before and/or after the current picture, an intra prediction technology predicting pixel values included in a current picture using pixel information in the current picture, an entropy coding technology allocating a short code to symbols having a high appearance frequency and a long code to symbols having a low appearance frequency, or the like, may be used.

An example of the video compression technology may include a technology providing a predetermined network bandwidth under a limited operation environment of hardware, without considering a flexible network environment. However, in order to compress video data applied to the network environment in which the bandwidth is frequently changed, a new compression technology is required. To this end, a scalable video coding/decoding method may be used.

### DISCLOSURE

### Technical Problem

The present invention provides entropy coding method and apparatus capable of improving video compression efficiency.

The present invention also provides scalable video coding method and apparatus capable of improving video compression efficiency.

The present invention also provides entropy decoding method and apparatus capable of improving video compression efficiency.

The present invention also provides scalable video decoding method and apparatus capable of improving video compression efficiency.

### Technical Solution

In an aspect, there is provided an entropy decoding method for decoding a scalable video based on multiple layers, the method including: deriving context information on decoding object symbols by using at least one of context information on an object layer and context information on other layers; and performing entropy decoding on the decoding object symbols by using the derived context information, wherein the object layer is a layer including the decoding object symbols and the other layers, which are layers other than the object layers, are layers used to perform the decoding in the object layer.

### Advantageous Effects

As set forth above, the exemplary embodiments of the present invention can improve the entropy coding/decoding performance and the video compression efficiency.

### DESCRIPTION OF DRAWINGS

FIG. 1 is a block diagram showing a configuration of an video coding apparatus according to an exemplary embodiment of the present invention.

FIG. 2 is a block diagram showing a configuration of an video decoding apparatus according to an exemplary embodiment of the present invention.

FIG. 3 is a conceptual diagram schematically showing an exemplary embodiment of a scalable video coding structure using multiple layers to which the present invention may be applied.

FIG. 4 is a flow chart schematically showing an entropy coding method according to an exemplary embodiment of the present invention.

FIG. 5 is a flow chart schematically showing an entropy coding method including a context information deriving process according to an exemplary embodiment of the present invention.

FIG. 6 is a flow chart schematically showing an entropy coding method according to another exemplary embodiment of the present invention.

FIG. 7 is a flow chart schematically showing an entropy coding method according to another exemplary embodiment of the present invention.

FIG. 8 is a flow chart schematically showing an entropy coding method according to another exemplary embodiment of the present invention.

FIG. 9 is a flow chart schematically showing an entropy decoding method according to an exemplary embodiment of the present invention

FIG. 10 is a flow chart schematically showing an entropy decoding method including a context information deriving process according to an exemplary embodiment of the present invention.

FIG. 11 is a flow chart schematically showing an entropy decoding method according to another exemplary embodiment of the present invention.

FIG. 12 is a flow chart schematically showing an entropy decoding method according to an exemplary embodiment of the present invention

FIG. 13 is a flow chart schematically showing an entropy decoding method according to another exemplary embodiment of the present invention.

### MODE FOR INVENTION

Hereinafter, exemplary embodiments of the present invention will be described in detail with reference to the accompanying drawings. In describing exemplary embodiments of the present invention, well-known functions or constructions will not be described in detail since they may unnecessarily obscure the understanding of the present invention.

It will be understood that when an element is simply referred to as being ‘connected to’ or ‘coupled to’ another element without being ‘directly connected to’ or ‘directly coupled to’ another element in the present description, it may be ‘directly connected to’ or ‘directly coupled to’ another element or be connected to or coupled to another element, having the other element intervening therebetween. Further, in the present invention, ‘comprising’ a specific configuration will be understood that additional configuration may also be included in the embodiments or the scope of the technical idea of the present invention.

Terms used in the specification, ‘first’, ‘second’, etc. can be used to describe various components, but the components are not to be construed as being limited to the terms. The terms are only used to differentiate one component from other components. For example, the ‘first’ component may be named the ‘second’ component without being departed from the scope of the present invention and the ‘second’ component may also be similarly named the ‘first’ component.

Furthermore, constitutional parts shown in the embodiments of the present invention are independently shown so as to represent characteristic functions different from each other. Thus, it does not mean that each constitutional part is constituted in a constitutional unit of separated hardware or one software. In other words, each constitutional part includes each of enumerated constitutional parts for convenience. Thus, at least two constitutional parts of each constitutional part may be combined to form one constitutional part or one constitutional part may be divided into a plurality of constitutional parts to perform each function. The embodiment where each constitutional part is combined and the embodiment where one constitutional part is divided are also included in the scope of the present invention, if not departing from the essence of the present invention.

In addition, some of constituents may not be indispensable constituents performing essential functions of the present invention but be selective constituents improving only performance thereof. The present invention may be implemented by including only the indispensable constitutional parts for implementing the essence of the present invention except the constituents used in improving performance. The structure including only the indispensable constituents except the selective constituents used in improving only performance is also included in the scope of the present invention.

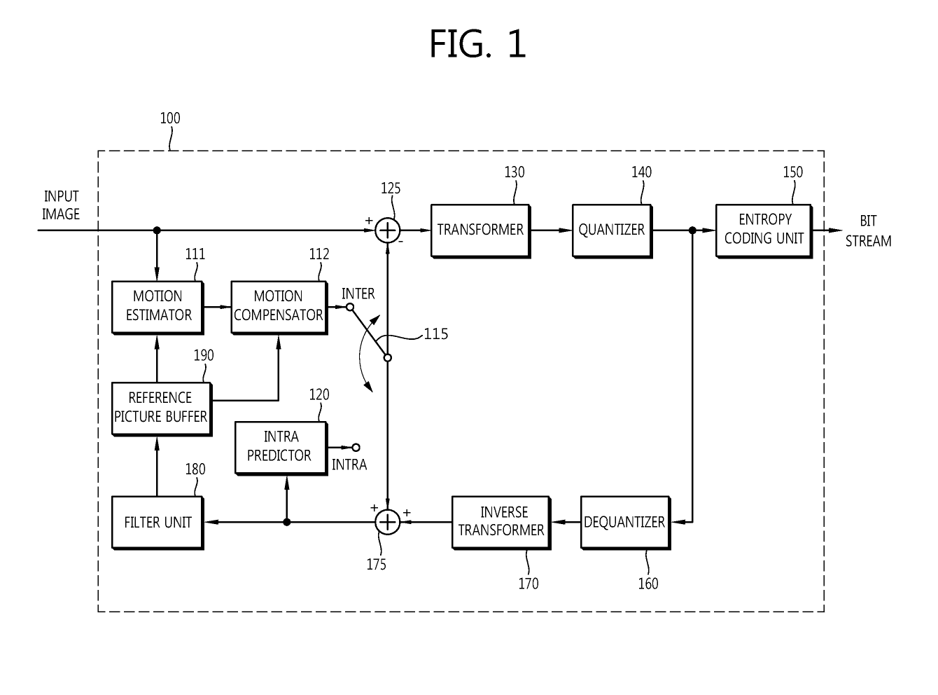

FIG. 1 is a block diagram showing a configuration of an video coding apparatus according to an exemplary embodiment of the present invention. Scalable video coding/decoding method or apparatus may be implemented by extension of general video coding/decoding method or apparatus that do not provide scalability. The block diagram of FIG. 1 shows an exemplary embodiment of the video coding apparatus that may be based on the scalable video coding apparatus.

Referring to FIG. 1, an video coding apparatus 100 includes a motion estimator 111, a motion compensator 112, an intra predictor 120, a switch 115, a subtractor 125, a transformer 130, a quantizer 140, an entropy coding unit 150, a dequantizer 160, a inverse transformer 170, an adder 175, a filter unit 180, and a reference picture buffer 190.

The video coding apparatus 100 performs coding on input pictures with an intra mode or an inter mode to output bit streams. The intra prediction means intra-picture prediction and the inter prediction means inter-picture prediction. In the case of the intra mode, the switch 115 is switched to intra and in the case of the inter mode, the switch 115 is switched to inter. The video coding apparatus 100 may generate a prediction block for an input block of the input pictures and then, code a difference between the input block and the prediction block.

In the case of the intra mode, the intra predictor 120 performs spatial prediction using the pixel values of the blocks coded in advance around the current block, thereby generating the prediction block.

In the case of the inter mode, the motion estimator 111 may obtain a motion vector by searching a region optimally matched with the input block in a reference picture stored in the reference picture buffer 190 during a motion estimation process. The motion compensator 112 performs motion compensation by using the motion vector and the reference picture stored in the reference picture buffer 190, thereby generating the prediction block.

The subtractor 125 may generate a residual block by the difference between the input block and the generated prediction block. The transformer 130 may output transform coefficients by performing a transform on the residual block. Further, the quantizer 140 quantizes the input transform coefficient according to quantization parameters to output quantized coefficients.

The entropy coding unit 150 performs entropy coding on symbols according to probability distribution based on values calculated in the quantizer 140, coding parameter values, or the like, calculated during the coding process to output bit streams. The entropy coding method is a method that receives the symbols having various values and represents the input symbols as decodable bin sequence/string while removing statistical redundancy.

In this case, the symbol means a coding/decoding object syntax element, a coding parameter, a value of a residual signal, or the like. The coding parameter, which is a parameter necessary for coding and decoding, may include information that is coded in the coder like the syntax element and transmitted to a decoder and information that may be derived during the coding process and decoding process and means the necessary information at the time of coding and decoding the pictures. The coding parameter may include, for example, the intra/inter prediction mode, the displacement/motion vector, a reference picture index, a coding block pattern, presence and absence of the residual signal, the transform coefficients, the quantized transform coefficients, quantization parameters, a block size, values or statistics of block division information, or the like. In addition, the residual signal may mean a difference between an original signal and a prediction signal. Further, the difference between the original signal and the prediction signal may mean a transformed type of signals or the difference between the original signal and the prediction signal may mean a transformed and quantized type of signals. The residual signal may be a residual block in a block unit.

When the entropy coding is applied, the entropy coding represents the symbols by allocating a small number of bits to the symbols having high occurrence probability and allocating a large number of bits to the symbols having low occurrence probability, thereby reducing a size of the bit streams for the coding object symbols. Therefore, the compression performance of the video coding may be increased through the entropy coding.

For the entropy coding, a coding method such as exponential golomb, context-adaptive variable length coding (CAVLC), context-adaptive binary arithmetic coding (CABAC), or the like, may be used. For example, the entropy coding unit 150 may be stored with a table for performing the entropy coding such as a variable length coding/code (VLC) table and the entropy coding unit 150 may use a stored variable length coding (VLC) table to perform the entropy coding. In addition, the entropy coding unit 150 may also perform the entropy coding by deriving a binarization method of the object symbols and a probability model of the object symbols/bins and then, using the derived binarization method or probability model.

In this case, the binarization means that the values of the symbols are represented as a bin sequence/string. The bin means each binary value (0 or 1) when the symbols are represented as the bin sequence/string through the binarization.

The probability model means the predicted probability of the coding/decoding object symbols/bins that may be derived through context information/context model. The context information/context model means information for determining the probability of the coding/decoding object symbols/bins.

In more detail, the CABAC entropy coding method binarizes the symbols that are not binarized into the bins, determines the context model by using the coding information on the peripheral and coding object blocks or the information on the coded symbols/bins at a previous step, and generates the bit stream by performing arithmetic coding of the bin by predicting the occurrence probability of the bin according to the determined context model. In this case, the CABAC entropy coding method may determine the context model and then, update the context model by using the information on the coded symbols/bins.

The quantized coefficient may be dequantized in the dequantizer 160 and inversely transformed in the inverse transformer 170. The dequantized, inverse transformed coefficients are added to the prediction block through the adder 175, thereby generating a reconstructed block.

The reconstructed block passes through the filter unit 180 and the filter unit 180 may apply at least one of a deblocking filter, sample adaptive offset (SAO), and an adaptive loop filter (ALF) to a reconstructed block or a reconstructed picture. The reconstructed block passing through the filter unit 180 may be stored in the reference picture buffer 190.

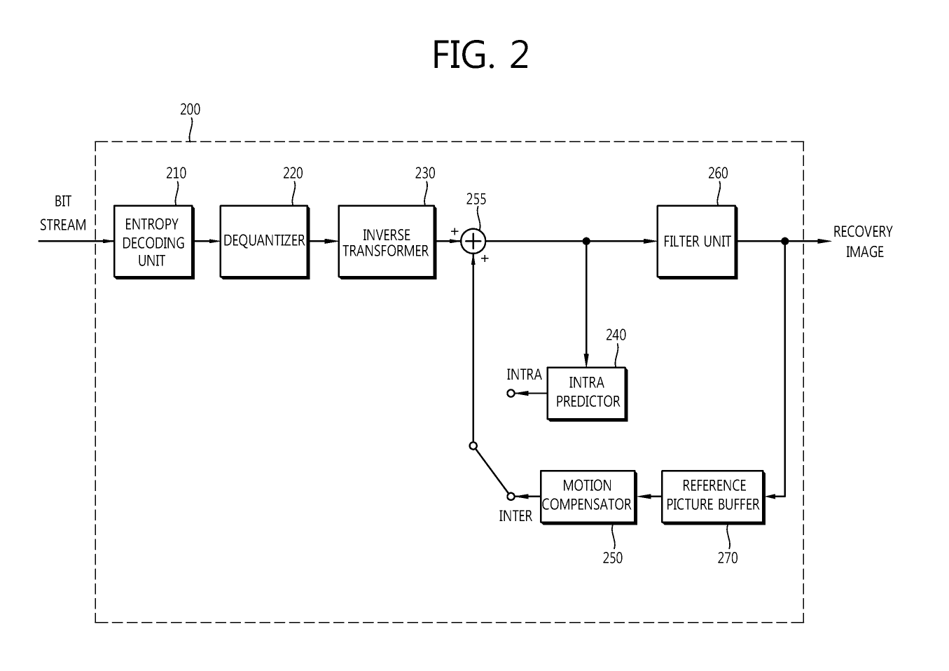

FIG. 2 is a block diagram showing a configuration of a video decoding apparatus according to an exemplary embodiment of the present invention. As shown in FIG. 1, the scalable video encoding/decoding method or apparatus may be implemented by the extension of the general video coding/decoding method or apparatus that do not provide the scalability. The block diagram of FIG. 2 shows an exemplary embodiment of the video decoding apparatus that may be based on the scalable video decoding apparatus.

Referring to FIG. 2, a video decoding apparatus 200 includes an entropy decoding unit 210, a dequantizer 220, a inverse transformer 230, an intra predictor 240, a motion compensator 250, a filter unit 260, and a reference picture buffer 270.

The video decoding apparatus 200 receives the bit streams output from the coder to perform the decoding with the intra mode or the inter mode and output the reconfigured picture, that is, the reconstructed picture. In the case of the intra mode, the switch may be switched to the intra and in the case of the inter mode, the switch may be switched to the inter mode. The video decoding apparatus 200 obtains the reconstructed residual block from the received bit streams and generates the prediction block and then, add the reconstructed residual block and the prediction block, thereby generating the reconfigured block, that is, the reconstructed block.

The entropy decoding unit 210 performs the entropy decoding on the input bit streams according to the probability distribution, thereby generating the symbols having the quantized coefficient type of symbols. The entropy decoding method is a method that receives the bin sequence/string and generates each symbols. The entropy decoding method is similar to the above-mentioned entropy coding method.

In more detail, the CABAC entropy decoding method may receive the bin corresponding to each syntax element in the bit streams, use the decoding object syntax element information and the decoding information on the peripheral and decoding object block or the information on the decoded symbols/bins at the previous step to determine the context model, and predict the occurrence probability of the bin according to the determined context model and performs the arithmetic decoding of the bin to generate the symbols corresponding to the values of each syntax element. In this case, the CABAC entropy decoding method may determine the context model and then, update the context model by using the information on the decoded symbols/bins.

When the entropy decoding method is applied, the entropy decoding method represents the symbols by allocating a small number of bits to the symbols having high occurrence probability and allocating a large number of bits to the symbols having low occurrence probability, thereby reducing the size of the bit streams for each symbol. Therefore, the compression performance of the video decoding may be increased through the entropy decoding method.

The quantized coefficients are dequantized in the dequantizer 220 and are inversely transformed in the inverse transformer 230. The quantized coefficients may be dequantized/inversely transformed to generate the reconstructed residual block.

In the case of the intra mode, the intra predictor 240 performs the spatial prediction using the pixel values of the blocks coded in advance around the current block, thereby generating the prediction block. In the case of the inter mode, the motion compensator 250 performs the motion compensation by using the motion vector and the reference picture stored in the reference picture buffer 270, thereby generating the prediction block.

The reconstructed residual block and the prediction block are added through the adder 255 and the added block passes through the filter unit 260. The filter unit 260 may apply at least one of the deblocking filter, the SAO, and the ALF to the reconstructed block or the reconstructed picture. The filter unit 260 outputs the reconfigured pictures, that is, the reconstructed pictures. The reconstructed pictures may be stored in the reference picture buffer 270 so as to be used for the inter-picture prediction.

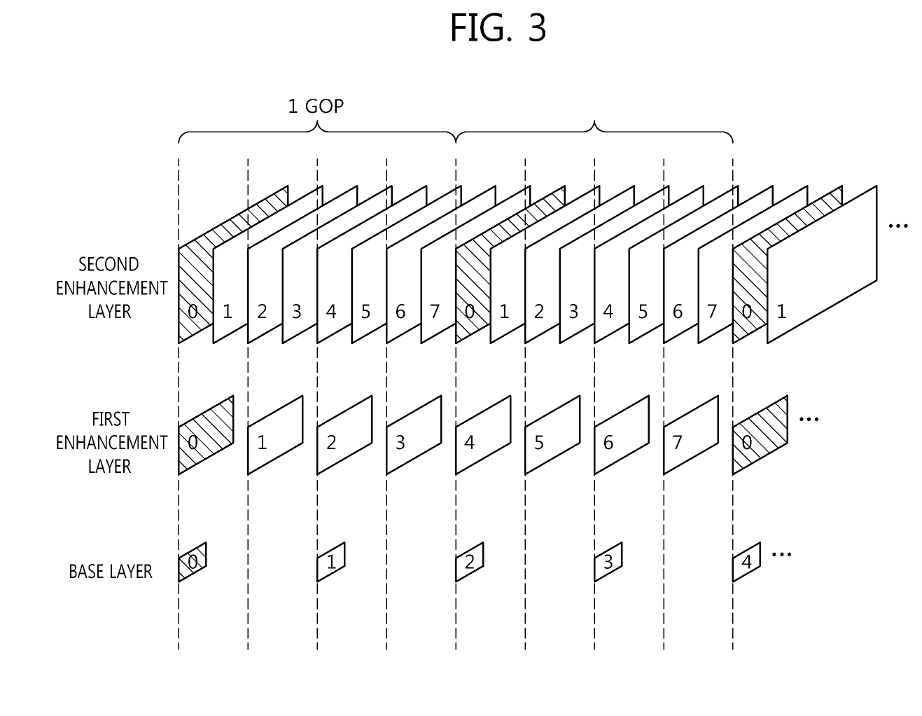

FIG. 3 is a conceptual diagram schematically showing an exemplary embodiment of a scalable video coding structure using multiple layers to which the present invention may be applied. In FIG. 3, a GOP represents a picture group, that is, a group of pictures.

So as to transmit the video data, transmission media are required and for each transmission medium, the performance thereof is different according to various network environments. In order to apply to various transmission media or network environments, a scalable video coding method may be provided.

The scalable video coding method is a coding method that uses texture information between the layers, the motion information, the residual signals, or the like, to remove the redundancy between the layers, thereby increasing the coding/decoding performance. The scalable video coding method may provide various scalabilities in terms of space, time, and video quality according to peripheral conditions such as transmission bit rate, transmission error rate, system resources, or the like.

The scalable video coding may be performed using a structure of multiple layers so as to provide the bit streams that may be applied to various network conditions. For example, the scalable video coding structure may include a base layer that compresses and processes the video data using a general video coding method and may include an enhancement layer that compresses and processes the video data using both of the coding information on the base layer and the general video coding method.

Herein, the layer means a set of the pictures and the bit streams that are divided based on a space (for example, picture size), time (for example, coding order, picture output order), picture quality, complexity, or the like. In addition, the multiple layers may have dependency therebetween.

Referring to FIG. 3, for example, the base layer may be defined by a quarter common intermediate format (QCIF), a frame rate of 15 Hz, and a bit rate of 3 Mbps, a first enhancement layer may be defined by a common intermediate format (CIF), a frame rate of 30 Hz, and a bit rate of 0.7 Mbps, and a second enhancement layer may be defined by standard definition (SD), a frame rate of 60 Hz, and a bit rate of 0.19 Mbps. The format, the frame rate, the bit rate, or the like, are one example, but may be defined differently, if necessary. In addition, the number of used layers is not limited to the present exemplary embodiment, but may be defined differently according to the conditions.

In this case, if CIF 0.5 Mbps bit stream is required, the bit stream may be transmitted in pieces so that the bit rate in the first enhancement layer is 0.5 Mbps. The scalable video coding method may provide temporal, spatial, and quality scalability according to the above-mentioned method in the exemplary embodiment of FIG. 3.

Hereinafter, an object layer, an object picture, an object slice, an object unit, an object block, an object symbol, and an object bin each mean a layer, a picture, a slice, a unit, a block, a symbol, and a bin that are currently coded or decoded. For example, the object layer may be a layer to which the object symbols pertain. In addition, other layers, which are layers other than the object layer, mean a layer that may be used in the object layer. That is, other layers may be used for the decoding process in the object layer. The layer that may be used in the object layer may be, for example, the lower temporal, spatial, quality layer.

In addition, a corresponding layer, a corresponding picture, a corresponding slice, a corresponding unit, a corresponding block, a corresponding symbol, and a corresponding bin each means a layer, a picture, a slice, a unit, a block, a symbol, and a bin corresponding to an object layer, an object picture, an object slice, an object unit, an object block, an object symbol, and an object bin. The corresponding picture means pictures of other layers that are present at the same temporal axis as the object picture. When the picture within the object layer is the same as the display order of the pictures within other layers, the picture within the layer different from the picture within the object layer may be present at the same temporal axis. Whether the pictures are present at the same temporal axis may be identified using the coding parameters such as a picture order count (POC). The corresponding slice means a slice that is present at a corresponding position that is spatially equal to or similar to the object slice of the object picture, within the corresponding picture. The corresponding unit means a unit that is present at a corresponding position that is spatially equal to or similar to the object unit of the object picture, within the corresponding picture. The corresponding block means a block that is present at a corresponding position that is spatially equal to or similar to the object block of the object picture, within the corresponding picture.

In addition, the slice representing a unit in which the picture is divided is used as a meaning collectively called a division unit such as a tile, an entropy slice, or the like. The video coding and decoding may be separately performed between each divided unit.

In addition, the block means a unit of the video coding and decoding. In the case of the video coding and decoding, when the coding or decoding is performed by dividing the single picture into the subdivided units, the coding or decoding unit means the divided unit, which may be called a macro block, a coding unit (CU), a prediction unit (PU), a transform unit (TU), a transform block, or the like. The single block may be further divided into a lower block having a smaller size.

In addition, the scalable video coding has the same meaning as the scalable video coding in terms of the coding and the scalable video decoding in terms of the decoding.

In the entropy coding/decoding method used in the general video compression technology that does not provide the scalability, the context information on the object layer is used and the context information on other layers usable in the scalable video coding method, or the like, is not used.

In the scalable video coding method, the redundancy between the layers may be removed using the texture information, the motion information, and the residual signal information, or the like, between the layers. However, after the coding parameters, the final residual signals, or the like, are obtained, the entropy coding/decoding may be independently performed in each layer. In this case, the scalable video coding method may have a limitation in improving the coding performance.

Therefore, in the scalable video coding method, when performing the entropy coding/decoding on the coding/decoding object information (coding parameter, symbols such as the residual signals, or the like) of the object layer, a method of using both of the context information on the object layer and the context information on other layers may be provided. In this case, in performing the scalable video coding/decoding method, when the entropy coding/decoding is performed using the information between the layer and thus, the compression performance of the video coding/decoding may be improved.

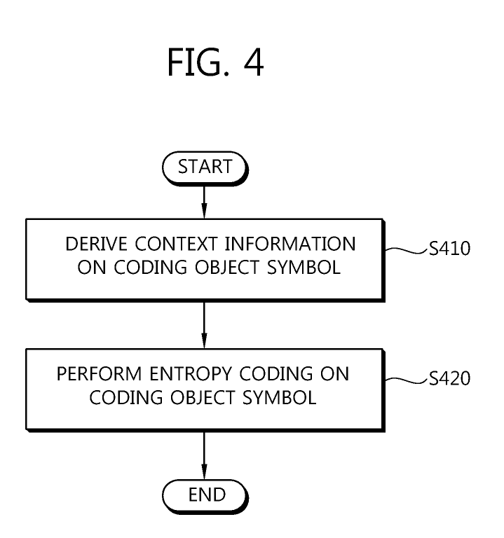

FIG. 4 is a flow chart schematically showing an entropy coding method according to an exemplary embodiment of the present invention.

Referring to the exemplary embodiment of FIG. 4, the entropy coding unit of the coder derives the context information on the coding object symbols (S410). As described above, the context information on the coding object symbols may be derived using the context information within the object layer and may also be derived using the context information within other layers.

The context information within the object layer or other layers may include a value and a combination of values and a frequency and a combination of frequencies of the symbols and/or bins that are present within the object layer or other layers. Hereinafter, the combination of values of the symbols/bins is collectively called the information on the values of the symbols/bins and the combination of the frequencies of the symbols/bins is collectively called the information on the frequencies of the symbols/bins. Hereinafter, the combination of values of the bins is collectively called the information on the values of the bin and the combination of the frequencies of the bins is collectively called the information on the frequencies of the bin.

The type of the context information on the object layer or other layers used for deriving the context information on the coding object symbols may be diverse.

As described above, the context information on the coding object symbols may be derived using the context information within the object layer. As the exemplary embodiment of the context information within the object layer used for deriving the context information on the coding object symbols, there may be the following context information types.

1. The context information within the object layer may be the same as the coding object symbols/bins and may be the information on the values and frequencies of the symbols/bins that are coded in advance according to the coding order in the object layer.

2. The context information within the object layer may be associated or depend on the coding object symbols/bins and may be the information on the values and frequencies of the symbols/bins that are coded in advance according to the coding order in the object layer.

3. The context information within the object layer, which is the same symbols/bins as the coding object symbols/bins, may be the information on the values and frequencies of all the symbols/bins that are present within the pictures, the slices, the units, or the blocks of the object layer.

4. The context information within the object layer, which is the symbols/bins present in the coding object slices, the units, or the blocks within the object layer, is the same as the coding object symbols/bins and may be the information on the values and frequencies of the symbols/bins that are coded in advance. In this case, the slices, the units, or the blocks may be the slices, the units, or the blocks in which the specific coding object symbols/bins are present.

5. The context information within the object layer, which is the symbols/bins present in the coding object slices, the units, or the blocks within the object layer, is the same as the coding object symbols/bins and may be the information on the spatial position and the scanning position of the symbols/bins that are coded in advance. In this case, the slices, the units, or the blocks may be the slices, the units, or the blocks in which the specific coding object symbols/bins are present.

6. The context information within the object layer may be the same as the coding object bin and may be the information on the values and frequencies of bins that are coded in advance, in the specific coding object symbols that are present in the object layer.

7. The context information within the object layer, which is the symbols/bins present in units around the coding object unit or the block around the coding object block in the object layer, may be the same as the coding object symbols/bins and may be the information on the values and frequencies of the symbols/bins that are coded in advance. In this case, the coding object unit or the coding object block may be the unit or the block in which the specific coding object symbols/bins are present.

The context information on the coding object symbols may be derived using the context information within other layers. As the exemplary embodiment of the context information within other layers used for deriving the context information on the coding object symbols, there may be the following context information type.

1. The context information within other layers, which is the same symbols/bins as the coding object symbols/bins, may be the information on the values and frequencies of the symbols/bins that are coded in advance according to the coding order within the corresponding pictures, the corresponding slices, the corresponding units, or the corresponding blocks of other layers.

2. The context information within other layers, which is the symbols/bins associated with or depends on the coding object symbols/bins, may be the information on the values and frequencies of the symbols/bins that are coded in advance according to the coding order within the corresponding pictures, the corresponding slices, the corresponding units, or the corresponding blocks of other layers.

3. The context information within other layers, which is the same symbols/bins as the coding object symbols/bins, may be the information on the values and frequencies of all the symbols/bins that are present within the corresponding pictures, the corresponding slices, the corresponding units, or the corresponding blocks of other layers.

4. The context information within other layers, which is the same symbols/bins as the coding object symbols/bins, may be the information on the spatial position and the scanning position of the symbols/bins that are coded in advance within the corresponding pictures, the corresponding slices, the corresponding units, or the corresponding blocks of other layers.

5. The context information within other layers may be the same as the coding object bin and may be the information on the values and frequencies of the bins that are coded in advance, in the symbols that are present in the corresponding pictures, the corresponding slices, the corresponding units, or the corresponding blocks of other layers. In this case, the symbols may be the same as the specific coding object symbol.

6. The context information within other layers, which is the symbols/bins present in the slices around the corresponding slices, the units around the corresponding unit, or the blocks around the corresponding blocks in other layers, may be the same as the coding object symbols/bins and may be the information on the values and frequencies of the symbols/bins that are coded in advance. In this case, the corresponding slices, the corresponding units, or the corresponding blocks may be the slices, the units, or the blocks in which the same symbols/bins as the specific coding object symbols/bins is present.

7. The context information within other layers may be the context information used for the coding of the corresponding pictures, the corresponding slices, the corresponding units, or the corresponding blocks of other layers. That is, the context information on the coding object symbols/bins within the object layer may be initialized using the context information on the corresponding pictures, the corresponding slices, the corresponding units, or the corresponding blocks of other layers.

8. The context information within other layers may be the context information used for the coding of the corresponding pictures, the corresponding slices, the corresponding units, or the corresponding blocks of other layers. That is, the context information on the coding object symbols/bins within the object layer may be initialized using the context information on the coded symbols/bins within other layers.

The entropy coding unit of the coder uses at least one of the context information within the above-mentioned object layer and the context information with other layers, thereby deriving the context information on the coding object symbols.

Referring again to the exemplary embodiment of FIG. 4, the entropy coding unit of the coder performs the entropy coding on the coding object symbols by using the derived context information (S420).

According to the exemplary embodiment of the present invention, the context information on other layers may be used for the entropy coding in the object layer during the scalable video coding process, such that the probability characteristics of the coding object symbols/bins may be more accurately predicted. Therefore, the compression performance of the video coding may be improved.

The coder may use an explicit method for informing the decoder of the information on whether the context information on any layer among the context information within the object layer and the context information within other layers is used. In addition, an implicit method may also be used so that the information obtained in the coder may be equally obtained even in the decoder.

When the explicit method is used, the coder may generate, transmit, and/or store flags including the information indicating whether the context information within the object layer is used and/or the information indicating whether the context information within other layers is used, as one exemplary embodiment. In this case, the decoder may receive and/or store the flag from the coder. The decoder may derive the information on whether the context information within the object layer is used and/or the information on whether the context information within other layers is used by using the flag.

In the explicit method, when the context information within other layers is used, the coder may generate, transmit and/or store the flag indicating whether the context information on any layer among other layers is used, as one exemplary embodiment. In this case, the decoder may receive and/or store the flag from the coder. The decoder may derive the information on whether the context information on any layer among other layers is used by using the flag.

When the implicit method is used, the coder and decoder may derive the information on whether the context information on any layer is used by using the same method according to the coding parameter values of the object layer and other layers, as one exemplary embodiment. In this case, a method for deriving the context information that is equally used by the coder and the decoder may be previously defined between the coder and the decoder.

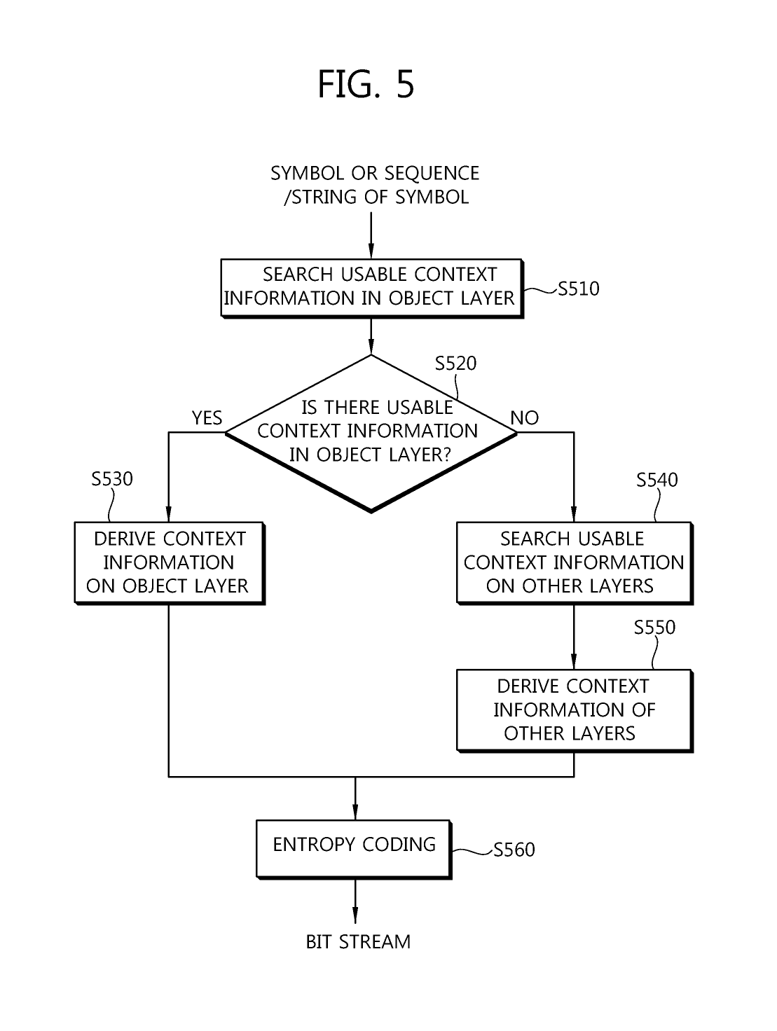

FIG. 5 is a flow chart schematically showing an entropy coding method including a context information deriving process according to an exemplary embodiment of the present invention.

Referring to FIG. 5, the coder searches whether the usable context information is present in the object layer, for the coding object symbols or the sequence/string of the symbols (S510). The coder determines whether the usable context information is present in the object layer according to the search result (S520).

If it is determined that the usable context information is present in the object layer, the coder derives the context information on the object layer (S530). The type of the context information within the object layer may be diverse and the exemplary embodiment of the context information usable within the object layer is already described in FIG. 4. Therefore, the context information derived from the coder may be the above-mentioned type or other types in the exemplary embodiment of FIG. 4.

If it is determined that the usable context information is not present in the object layer, the coder searches the context information usable in other layers (S540).

If it is determined that the usable context information is present in other layers, the coder derives the context information on other layers (S550). The type of the context information within other layers may also be diverse and the exemplary embodiment of the context information usable within other layers is already described in FIG. 4. Therefore, the context information derived from the coder may be the above-mentioned type or other types in the exemplary embodiment of FIG. 4.

The coder performs the entropy coding on the coding object symbols by using the derived context information (S560). The coder may generate the bit streams by performing the entropy coding.

The coder may inform the decoder of the information on whether the usable context information is present in the object layer and/or other layers according to the search and determination results. In addition, the coder may inform the decoder of the information on whether the context information on any layer among other layers is used. The information may equally be obtained in the coder and the decoder by the implicit method.

According to the exemplary embodiment of FIG. 5, the context information on other layers may be used to perform the entropy coding in the object layer during the scalable video coding process. Therefore, the probability characteristics of the coding object symbols/bins may be more accurately predicted and the compression performance of the video coding may be improved.

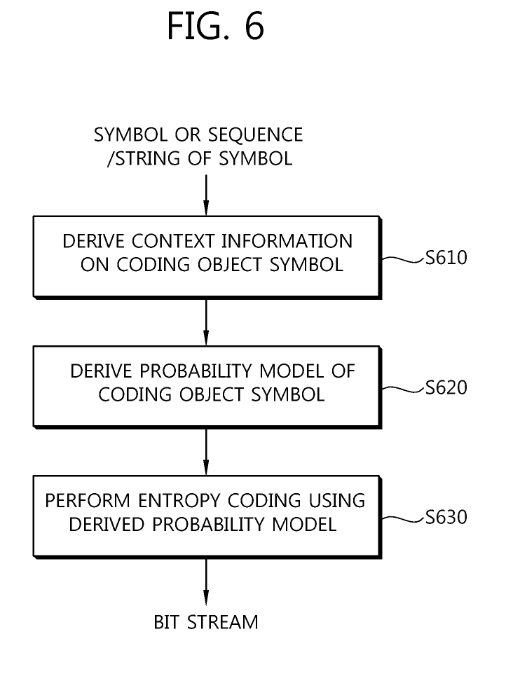

FIG. 6 is a flow chart schematically showing an entropy coding method according to another exemplary embodiment of the present invention.

Referring to the exemplary embodiment of FIG. 6, the coder derives the context information on the coding object symbols (S610). The context information on the coding object symbols may be derived using the context information within the object layer and may also be derived using the context information within other layers. In addition, the context information on the object layer and other layers may have various types as described above in the exemplary embodiment of FIG. 4.

The coder derives the probability model of the coding object symbols/bins by using the derived context information (S620). The derived context information may also be derived by the context information on other layers and therefore, the probability model of the coding object symbols/bins may be derived using the context information on the object layer and other layers.

The coder performs the entropy coding on the coding object symbols/bins by using the derived probability model (S630).

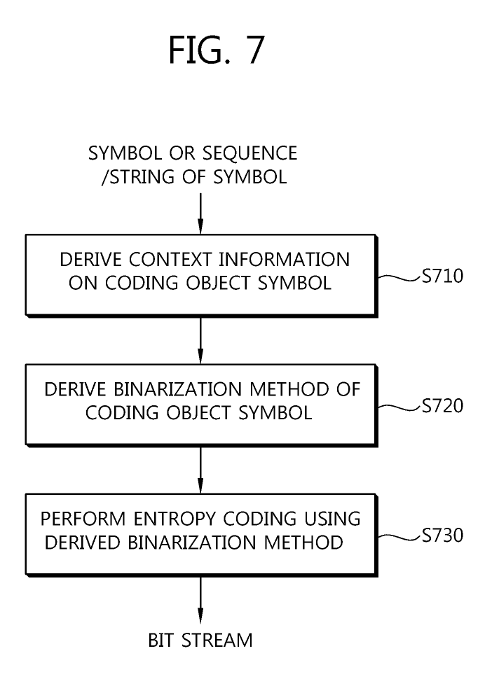

FIG. 7 is a flow chart schematically showing an entropy coding method according to another exemplary embodiment of the present invention.

Referring to the exemplary embodiment of FIG. 7, the coder derives the context information on the coding object symbols (S710). The context information on the coding object symbols may be derived using the context information within the object layer and may also be derived using the context information within other layers. In addition, the context information on the object layer and other layers may have various types as described above in the exemplary embodiment of FIG. 4.

The coder derives the binarization method of the coding object symbols by using the derived context information (S720). The derived context information may also be derived by the context information on other layers and therefore, the binarization method of the coding object symbols may be derived using the context information on the object layer and other layers.

The coder performs the entropy coding on the coding object symbols by using the derived binarization method (S730).

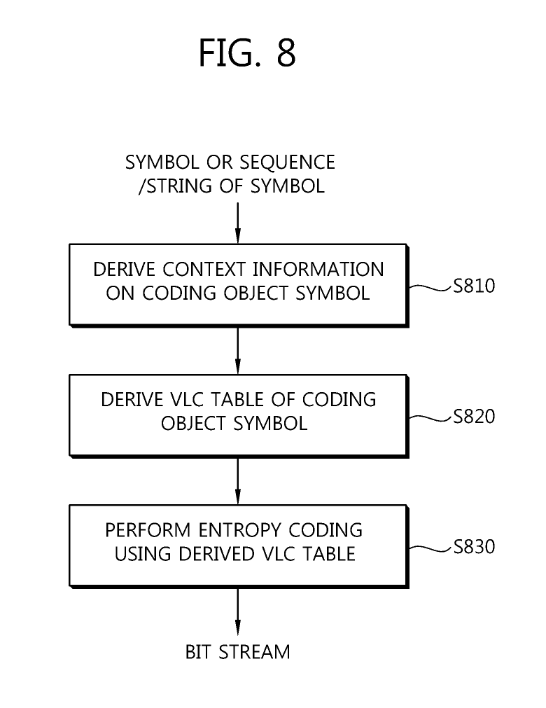

FIG. 8 is a flow chart schematically showing an entropy coding method according to another exemplary embodiment of the present invention.

Referring to the exemplary embodiment of FIG. 8, the coder derives the context information on the coding object symbols (S810). The context information on the coding object symbols may be derived using the context information within the object layer and may also be derived using the context information within other layers. In addition, the context information within the object layer and other layers may have various types as described above in the exemplary embodiment of FIG. 4.

The coder derives the VLC table of the coding object symbols by using the derived context information (S820). The derived context information may also be derived by the context information on other layers and therefore, the VLC table of the coding object symbols may be derived using the context information on the object layer and other layers.

The coder performs the entropy coding on the coding object symbols by using the derived VLC (S830).

Referring to the exemplary embodiments of FIGS. 6 to 8, the context information on other layers may be used for the entropy coding and therefore, the probability characteristics of the coding object symbols/bins may be more accurately reflected. Therefore, the entropy coding performance and the video compression efficiency may be improved.

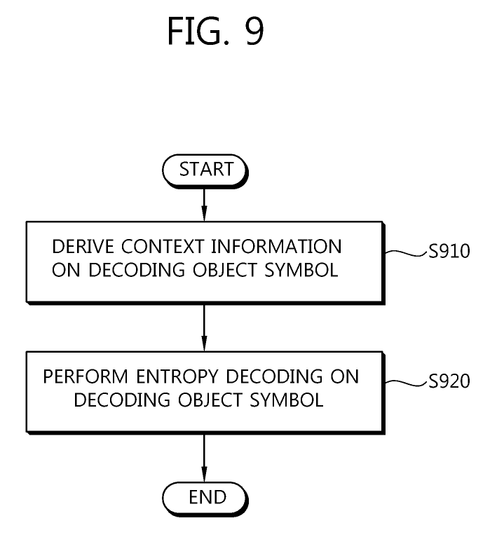

FIG. 9 is a flow chart schematically showing an entropy decoding method according to an exemplary embodiment of the present invention.

Referring to the exemplary embodiment of FIG. 9, the entropy decoding unit of the decoder derives the context information on the decoding object symbols (S910). As described above, the context information on the decoding object symbols may be derived using the context information within the object layer and may also be derived using the context information within other layers.

The type of the context information on the object layer or other layers used for deriving the context information on the decoding object symbols may be diverse.

The context information on the decoding object symbols may be derived using the context information within the object layer. As the exemplary embodiment of the context information within the object layer used for deriving the context information on the decoding object symbols, there may be the following context information types.

1. The context information within the object layer may be the same as the decoding object symbols/bins and may be the information on the values and frequencies of the symbols/bins that are decoded in advance according to the decoding order in the object layer.

2. The context information within the object layer is associated with or depends on the decoding object symbols/bins and may be the information on the values and frequencies of the symbols/bins that are decoded in advance according to the decoding order in the object layer.

3. The context information within the object layer, which is the same symbols/bins as the decoding object symbols/bins, may be the information on the values and frequencies of all the symbols/bins that are present within the pictures, the slices, the units, or the blocks of the object layer.

4. The context information within the object layer, which is the symbols/bins present in the decoding object slices, the units, or the blocks within the object layer, is the same as the decoding object symbols/bins and may be the information on the values and frequencies of the symbols/bins that are decoded in advance. In this case, the slice, the unit, or the block may be the slices, the units, or the blocks in which the specific decoding object symbols/bins are present.

5. The context information within the object layer, which is the symbols/bins present in the decoding object slices, the units, or the blocks within the object layer, is the same as the decoding object symbols/bins and may be the information on the spatial position and the scanning position of the symbols/bins that are decoded in advance. In this case, the slices, the units, or the blocks may be the slices, the units, or the blocks in which the specific decoding object symbols/bins are present.

6. The context information within the object layer may be the same as the decoding object bins and may be the information on the values and frequencies of bins that are decoded in advance, in the specific decoding object symbols that are present in the object layer.

7. The context information within the object layer, which is the symbols/bins present in units around the decoding object unit or the block around the decoding object block in the object layer, may be the same as the decoding object symbols/bins and may be the information on the values and frequencies of the symbols/bins that are decoded in advance. In this case, the decoding object unit or the decoding object blocks may be the units or the blocks in which the specific decoding object symbols/bins are present.

The context information on the decoding object symbols may be derived using the context information within other layers. As the exemplary embodiment of the context information within other layers used for deriving the context information on the decoding object symbols, there may be the following context information types.

1. The context information within other layers, which is the same symbols/bins as the decoding object symbols/bins, may be the information on the values and frequencies of the symbols/bins that are decoded in advance according to the decoding order within the corresponding pictures, the corresponding slices, the corresponding units, or the corresponding blocks of other layers.

2. The context information within other layers, which is the symbols/bins associated with or depends on the decoding object symbols/bins, may be the information on the values and frequencies of the symbols/bins that are decoded in advance according to the decoding order within the corresponding pictures, the corresponding slices, the corresponding units, or the corresponding blocks of other layers.

3. The context information within other layers, which is the same symbols/bins as the decoding object symbols/bins, may be the information on the values and frequencies of all the symbols/bins that are present within the corresponding pictures, the corresponding slices, the corresponding units, or the corresponding blocks of other layers.

4. The context information within other layers, which is the same symbols/bins as the decoding object symbols/bins, may be the information on the spatial position and the scanning position of the symbols/bins that are decoded in advance within the corresponding pictures, the corresponding slices, the corresponding units, or the corresponding blocks of other layers.

5. The context information within other layers may be the same as the decoding object bin and may be the information on the values and frequencies of the bins that are decoded in advance, in the symbols that are present in the corresponding pictures, the corresponding slices, the corresponding units, or the corresponding blocks of other layers. In this case, the symbols may be the same as the specific decoding object symbols.

6. The context information within other layers, which is the symbols/bins present in the slices around the corresponding slices, the units around the corresponding units, or the blocks around the corresponding blocks in other layers, may be the same as the decoding object symbols/bins and may be the information on the values and frequencies of the symbols/bins that are decoded in advance. In this case, the corresponding slices, the corresponding units, or the corresponding blocks may be the slices, the units, or the blocks in which the same symbols/bins as the specific decoding object symbols/bins is present.

7. The context information within other layers may be the context information used for the decoding of the corresponding pictures, the corresponding slices, the corresponding units, or the corresponding blocks of other layers. That is, the context information on the decoding object symbols/bins within the object layer may be initialized using the context information on the corresponding pictures, the corresponding slices, the corresponding units, or the corresponding blocks of other layers.

8. The context information within other layers may be the context information used for the decoding of the corresponding pictures, the corresponding slices, the corresponding units, or the corresponding blocks of other layers. That is, the context information on the decoding object symbols/bins within the object layer may be initialized using the context information on the decoded symbols/bins within other layers.

The entropy decoding unit of the decoder uses at least one of the context information within the above-mentioned object layer and the context information within other layers, thereby deriving the context information on the decoding object symbols.

Referring again to the exemplary embodiment of FIG. 9, the entropy decoding unit of the decoder performs the entropy decoding on the decoding object symbols by using the derived context information (S920).

According to the exemplary embodiment of the present invention, the context information on other layers may be used for the entropy decoding performance in the object layer during the scalable video decoding process, such that the probability characteristics of the decoding object symbols/bins may be more accurately predicted. Therefore, the compression performance of the video decoding may be improved.

The decoder may receive the information on whether the context information on any layer among the context information within the object layer and the context information within other layers is used from the coder by the explicit method and may derive the information by the implicit method.

As described above in the exemplary embodiment of FIG. 4, when the explicit method is used, the decoder may receive the flag including the information indicating whether the context information within the object layer is used and/or the information indicating whether the context information within other layers is used. In addition, the decoder may also receive the flag indicating whether the context information on any layer among other layers is uses. In this case, the decoder may obtain the information on whether the context information on any layer is used by using the flag.

When the implicit method is used, the coder and decoder may derive the information on whether the context information on any layer is used by using the same method according to the coding parameter values of the object layer and other layers, as one exemplary embodiment.

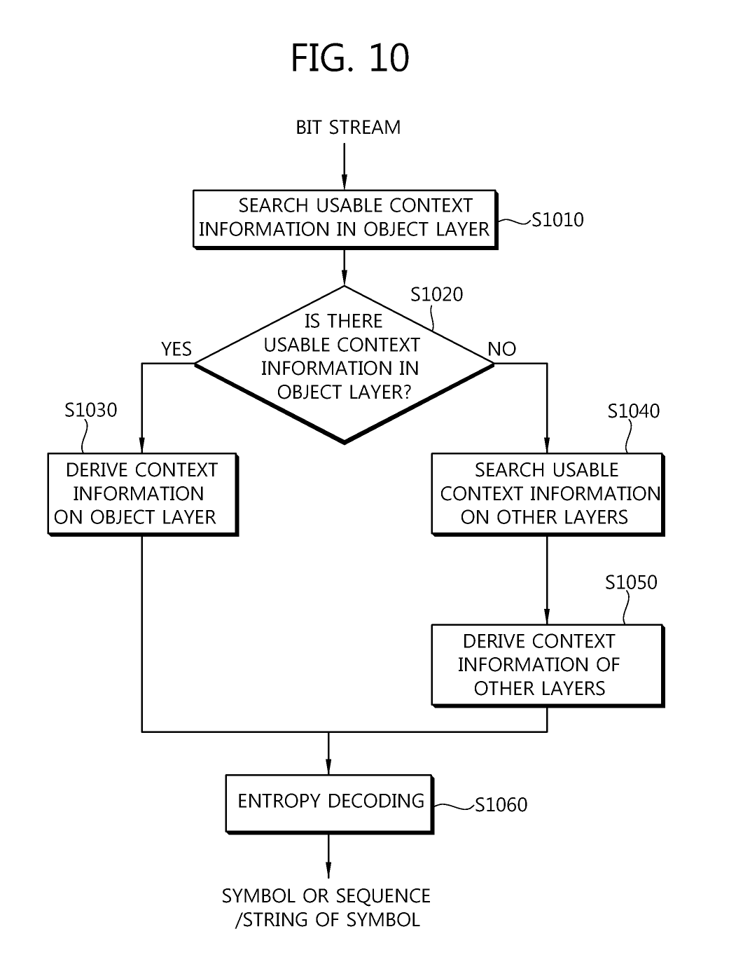

FIG. 10 is a flow chart schematically showing an entropy decoding method including a context information deriving process according to an exemplary embodiment of the present invention.

Referring to FIG. 10, the decoder receives the bit streams to search whether the usable context information is present in the object layer for the decoding object symbols (S1010). The decoder determines whether the usable context information is present in the object layer according to the search result (S1020). In this case, the decoder may search and determine whether the context information is present in the object layer through the flag information transmitted from the coder. In addition, the decoder may search and determine whether the context information is present in the object layer by using the same method as the coder according to the coding parameter values.

If it is determined that the usable context information is present in the object layer, the decoder derives the context information on the object layer (S1030). The type of the context information within the object layer may be diverse and the exemplary embodiment of the context information usable within the object layer is already described in FIG. 9. Therefore, the context information derived from the decoder may be the above-mentioned type or other types in the exemplary embodiment of FIG. 9.

If it is determined that the usable context information is not present in the object layer, the decoder searches the usable context information on other layers (S1040). In this case, the decoder may search and determine whether the context information is present in other layers through the flag information transmitted from the coder. In addition, the decoder may search and determine whether the context information is present in other layers by using the same method as the coder according to the coding parameter values.

If it is determined that the usable context information is present in other layers, the decoder derives the context information on other layers (S1050). The type of the context information within other layers may also be diverse and the exemplary embodiment of the context information usable within other layers is already described in FIG. 9. Therefore, the context information derived from the decoder may be the above-mentioned type or other types in the exemplary embodiment of FIG. 9.

The decoder performs the entropy decoding on the decoding object symbols by using the derived context information (S1060). The decoder may generate the sequence/string of the symbol or the symbols by performing the entropy decoding.

According to the exemplary embodiment of FIG. 10, the context information on other layers may be used to perform the entropy decoding in the object layer during the scalable video decoding process. Therefore, the probability characteristics of the decoding object symbols/bins may be more accurately predicted and the performance of the video decoding may be improved.

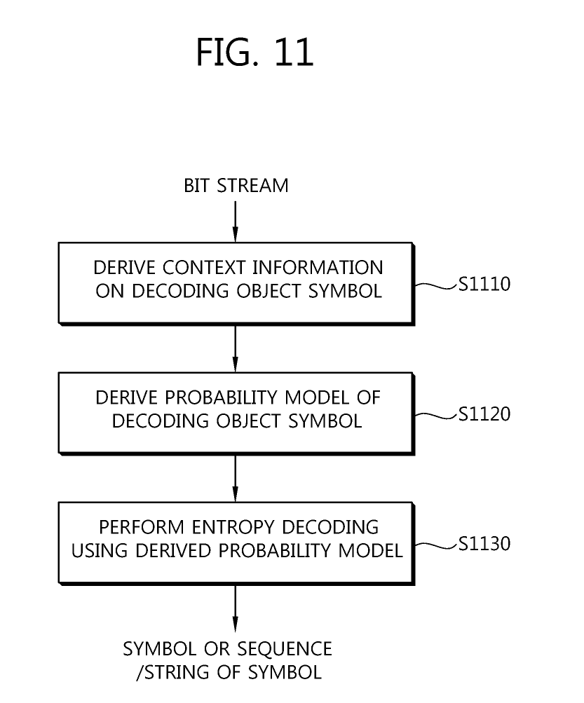

FIG. 11 is a flow chart schematically showing an entropy decoding method according to another exemplary embodiment of the present invention.

Referring to the exemplary embodiment of FIG. 11, the decoder derives the context information on the decoding object symbols (S1110). The context information on the decoding object symbols may be derived using the context information within the object layer and may also be derived using the context information within other layers. In addition, the context information within the object layer and other layers may have various types as described above in the exemplary embodiment of FIG. 9.

The decoder derives the probability model of the decoding object symbols/bins by using the derived context information (S1120). The derived context information may also be derived by the context information on other layers and therefore, the probability model of the decoding object symbols/bins may be derived using the context information on the object layer and other layers.

The decoder performs the entropy decoding on the decoding object symbols/bins by using the derived probability model (S1130).

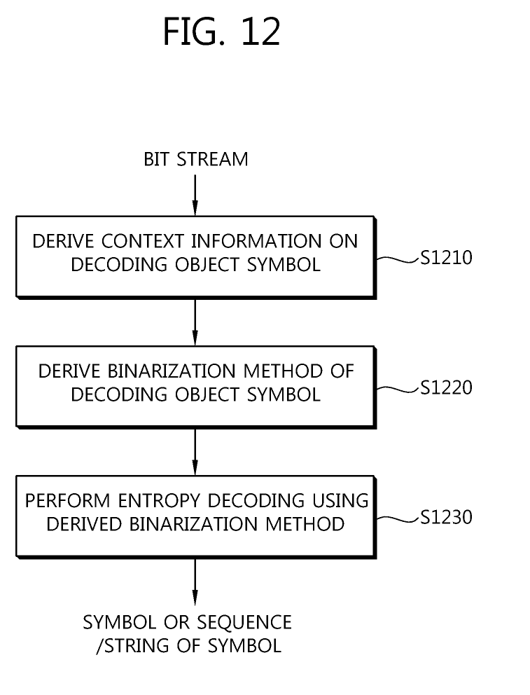

FIG. 12 is a flow chart schematically showing an entropy decoding method according to an exemplary embodiment of the present invention

Referring to the exemplary embodiment of FIG. 12, the decoder derives the context information on the decoding object symbols (S1210). The context information on the decoding object symbols may be derived using the context information within the object layer and may also be derived using the context information within other layers. In addition, the context information within the object layer and other layers may have various types as described above in the exemplary embodiment of FIG. 9.

The decoder derives the binarization method of the decoding object symbols by using the derived context information (S1220). The derived context information may also be derived by the context information on other layers and therefore, the binarization method of the decoding object symbols may be derived using the context information on the object layer and other layers.

The decoder performs the entropy decoding on the decoding object symbols by using the derived binarization method (S1230).

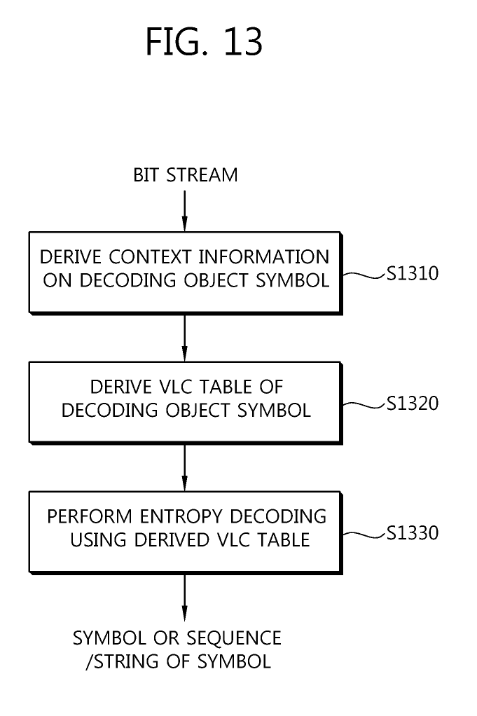

FIG. 13 is a flow chart schematically showing an entropy decoding method according to another exemplary embodiment of the present invention.

Referring to the exemplary embodiment of FIG. 13, the decoder derives the context information on the decoding object symbols (S1310). The context information on the decoding object symbols may be derived using the context information within the object layer and may also be derived using the context information within other layers. In addition, the context information within the object layer and other layers may have various types as described above in the exemplary embodiment of FIG. 9.

The decoder derives the VLC table of the decoding object symbols by using the derived context information (S1320). The derived context information may also be derived by the context information on other layers and therefore, the VLC table of the decoding object symbols may be derived using the context information on the object layer and other layers.

The decoder performs the entropy decoding on the decoding object symbols by using the derived VLC table (S1330).

Referring to the exemplary embodiments of FIGS. 11 to 13, the context information on other layers may be used for the entropy decoding and therefore, the probability characteristics of the decoding object symbols/bins may be more accurately reflected. Therefore, the entropy decoding performance and the video compression efficiency may be improved.

In the above-mentioned exemplary embodiments, the methods are described based on the series of steps or the flow charts shown by a block, but the exemplary embodiments of the present invention are not limited to the order of the steps and any steps may be performed in order different from the above-mentioned steps or simultaneously. In addition, a person skilled in the art to which the present invention pertains may understand that steps shown in the flow chart are not exclusive and thus, may include other steps or one or more step of the flow chart may be deleted without affecting the scope of the present invention.

The above-mentioned embodiments include examples of various aspects. Although all possible combinations showing various aspects are not described, it may be appreciated by those skilled in the art that other combinations may be made. Therefore, the present invention should be construed as including all other substitutions, alterations and modifications belonging to the following claims.

1. An entropy decoding method for a scalable video based on multiple layers, the method comprising:
deriving context information on decoding object symbols by using at least one of context information on an object layer and context information on other layers; and
performing entropy decoding on the decoding object symbols by using the derived context information,
wherein the object layer is a layer including the decoding object symbols and the other layers, which are layers other than the object layer, are layers used to perform the decoding in the object layer.

2. The entropy decoding method claim 1, wherein the context information on the other layers is symbols/bins equal to decoding object symbols/bins, and comprises at least one of information on values and frequencies of symbols/bins that are decoded in advance according to a decoding order within corresponding pictures, corresponding slices, corresponding units, or corresponding blocks of the other layers, information on values and frequencies of all the symbols/bins that are present within the corresponding pictures, the corresponding slices, the corresponding units, or the corresponding blocks of the other layers, and information on a spatial position and a scanning position of symbols/bins that are decoded in advance within the corresponding pictures, the corresponding slices, the corresponding units, or the corresponding blocks of the other layers.

3. The entropy decoding method claim 1, wherein the context information on the other layers is symbols/bins associated with or depends on decoding object symbols/bins, and comprises information on values and frequencies of symbols/bins that are decoded in advance according to a decoding order within corresponding pictures, corresponding slices, corresponding units, or corresponding blocks of the other layers.

4. The entropy decoding method claim 1, wherein the context information on the other layers is equal to decoding object symbols/bins as symbols/bins that are present within corresponding pictures, corresponding slices, slices around the corresponding slices, corresponding units, units around the corresponding unit, corresponding blocks, blocks around the corresponding blocks of the other layers, and comprises information on values and frequencies of symbols/bins that are decoded in advance.

5. The entropy decoding method claim 1, wherein the context information on the other layers comprises context information used for decoding corresponding pictures, corresponding slices, corresponding units, or corresponding blocks of the other layers.

6. The entropy decoding method claim 1, wherein the deriving of the context information comprises receiving at least one of flags including the information indicating whether the context information within the object layer is used and/or the information indicating whether the context information within other layers is used and flag indicating whether the context information on any layer among other layers is used.

7. The entropy decoding method claim 1, wherein the deriving of the context information comprises deriving information on whether context information on any layer is used by using a method equal to a coding method according to coding parameter values of the object layer and the other layers.

8. The entropy decoding method claim 1, wherein the deriving of the context information comprises:
receiving bit streams to determine whether usable context information is present in the object layer with respect to the decoding object symbols;
deriving the context information on the object layer when usable context information is present in the object layer, and determining whether the usable context information is present in the other layers when usable context information is not present in the object layer; and
deriving the context information on the other layer when usable context information is present in the other layer.

9. A video decoding apparatus for a scalable video based on multiple layers, the video decoding apparatus comprising:
an entropy decoding unit receiving bit streams, deriving context information on decoding object symbols by using at least one of context information on an object layer and context information on other layers, and performing entropy decoding on the decoding object symbols by using the derived context information,
wherein the object layer is a layer including the decoding object symbols and the other layers, which are layers other than the object layer, are layers used to perform the decoding in the object layer.

10. The video decoding apparatus claim 9, wherein the context information on the other layers is symbols/bins equal to decoding object symbols/bins, and comprises at least one of information on values and frequencies of symbols/bins that are decoded in advance according to a decoding order within corresponding pictures, corresponding slices, corresponding units, or corresponding blocks of the other layers, information on values and frequencies of all the symbols/bins that are present within the corresponding pictures, the corresponding slices, the corresponding units, or the corresponding blocks of the other layers, and information on a spatial position and a scanning position of symbols/bins that are decoded in advance within the corresponding pictures, the corresponding slices, the corresponding units, or the corresponding blocks of the other layers.

11. The video decoding apparatus claim 9, wherein the context information on the other layers is symbols/bins associated with or depends decoding object symbols/bins, and comprises information on values and frequencies of symbols/bins that are decoded in advance according to a decoding order within corresponding pictures, corresponding slices, corresponding units, or corresponding blocks of the other layers.

12. The video decoding apparatus claim 9, wherein the context information on the other layers is equal to decoding object symbols/bins as symbols/bins that are present within corresponding pictures, corresponding slices, slices around the corresponding slices, corresponding units, units around the corresponding unit, corresponding blocks, blocks around the corresponding blocks of the other layers, and comprises information on values and frequencies of symbols/bins that are decoded in advance.

13. The video decoding apparatus claim 9, wherein the context information on the other layers comprises context information used for decoding corresponding pictures, corresponding slices, corresponding units, or corresponding blocks of the other layers.

14. The video decoding apparatus claim 9, wherein the entropy decoding unit receives at least one of flags including the information indicating whether the context information within the object layer is used and/or the information indicating whether the context information within other layers is used and flag indicating whether the context information on any layer among other layers is used.

15. The video decoding apparatus claim 9, wherein the entropy decoding unit derives information on whether context information on any layer is used by using a method equal to a coding method according to coding parameter values of the object layer and the other layers.

16. The video decoding apparatus claim 9, wherein the entropy decoding unit determines whether usable context information is present in the object layer with respect to the decoding object symbols, derives the context information on the object layer when usable context information is present in the object layer, and determines whether the usable context information is present in the other layers when usable context information is not present in the object layer; and
derives the context information on the other layer when usable context information is present in the other layer.
